(19) United States
(12) Patent Application Publication
(10) Pub. No.: US 2007/0239560 A1
(43) Pub. Date: Oct. 11, 2007

(54) Cost-per-action market driven advertising fee sharing

(75) Inventors: Mark McGuire, Waunakee, WI (US); Brian Wiegand, Waunakee, WI (US)

Correspondence Address: BRINKS HOFER GILSON & LIONE, P.O. BOX 10395, CHICAGO, IL, 60610, US

(73) Assignee: Jellyfish, Inc.

(21) Appl. No.: 11/399,633

(22) Filed: Apr. 6, 2006

(51) Int. Cl. G06Q 30/00

(52) U.S. Cl. 705/26

(57) ABSTRACT

A competitive environment in which merchants compete for sales in a reverse auction format in which there are many sellers and a single buyer is disclosed. Merchants purchase prominent placement on product search results lists based on a negotiable per-sale fee. A customer discount is derived from the per-sale fee negotiated with each merchant. The customer discount may be shared with customers by subtracting the customer discount from a merchant market price. The result is a final customer price that determines the merchant's position in the product search results list. Merchants having the lowest final customer price are placed at the top of the search results list, while merchants having higher final customer prices are placed further down the list. Merchants may influence their position on the search results list by agreeing to pay a different amount for each sale.

### TECHNICAL FIELD

The present disclosure relates to an Internet search engine (ISE). More specifically, the disclosure relates to an ISE adapted to aggregate and display product and pricing data for a plurality of different products from a plurality of different merchants offering the products for sale.

### BACKGROUND

Over the years the Internet has become a robust and dynamic retail marketplace. Many retailers maintain a significant on-line presence and an increasing percentage of sales transactions take place on-line. The Internet provides consumers a convenient way to research products and compare prices. Rather than traveling from store to store to determine which model of a particular product best suits the shopper's needs and to determine which retail outlet provides the best price, Internet shopping allows customers to travel virtually from one merchant's website to another without leaving their home, office, or any other location from which they choose to surf the Web. By visiting a number of different websites, customers can quickly become acquainted with the various products available and the retailers who are selling them.

Various tools have been developed to help user's navigate the World Wide Web. Many of these tools may be enlisted by on-line shoppers to help locate websites containing information on products and services, and the retail outlets offering them for sale. For example, Internet search engines may be used to locate websites on substantially any subject. On-line shoppers may employ general purpose search engines to locate websites that contain information about specific products and services. The on-line shopper simply enters one or more search terms related to the product or service of interest into a search engine's search field, and the search engine returns a list of websites that use the search word, or contain the search word in metadata associated with the site. The list of websites typically includes hypertext links to the various websites.

Comparison shopping engines (CSEs) are another type of search tool developed to assist on-line shoppers identify products and locate merchants selling them. CSEs may be thought of as specialized Internet search engines dedicated to on-line shopping. CSEs are designed to aggregate or otherwise access product and pricing data on a large variety of product offered by many different merchants. CSEs may be configured similar to general purpose search engines where an online shopper types in a product name or other key word in a search field associated with the CSE, and the CSE returns various products that meet the shopper's search criteria. Once a desired product is identified the CSE may display various merchants offering the product along with pricing data and other information. CSEs are available in other forms as well. For example, a CSE may operate in the background as an on-line shopper visits various web sites using his or her internet browser. Such a CSE may have the ability to track the shopper's web browsing activity and determine the types of products the shopper is interested in based on the web sites the shopper visits. Once the CSE has determined a product of interest, the CSE may display many product alternatives, various offerings of the particular product from various merchants, the best priced offering of the particular product, or the product offering of a preferred merchant having an advertising arrangement with the CSE. The CSE may acquire and store product and pricing data in advance or may gather the data in real time once it determines the type of product the shopper is interested in. In short, a CSE may encompass any browsing or search tool configured to gather product and pricing data from various sources to be displayed for an on-line shopper in order to assist the shopper in finding the best product for his or her needs at the best price. Furthermore, CSEs need not be limited to operation on traditional web browsers and computers. Other communications channels and display apparatuses, may be employed as well. Virtually any two-way communication medium may be employed to enter search criteria and display product results. Wireless phones or other wireless hand held devices such as personal digital assistants, cable TV set-top boxes and TV monitors, and other devices may all be employed to search for products and display search results gathered by a CSE.

Search engines, comparison shopping engines, and other Internet search tools have been embraced by consumers and form an integral part of the on-line shopping environment. As such, they represent fertile grounds for advertising efforts. Almost from the very beginning of the World Wide Web advertisers and marketers have sought effective ways of getting their ads in front of as many eyes as possible and driving as much Internet traffic to their websites as possible. A hypertext link pointing to a particular website placed prominently at the top or near the top of a search engine query results list turns out to be an excellent way to drive Internet traffic to the desired web page. Often ISE search results contain many pages worth of hyper-text links to websites that for one reason or another contain a reference to the key words entered in a user's search query. Often the relationship between the websites listed in the search results and the user's search objectives is tenuous at best. More sophisticated ISEs employ proprietary ranking systems in which the most relevant links (as determined by the ISE) are placed at the top of the search results list. Because of their vertical focus, CSE's are better able to predict the intent of a searcher and the potential relevance of the links displayed.

Market research has shown that only a small fraction of the hypertext links returned in ISE search results lists are ever executed by the users who initiated the searches. Of the links that are executed, the overwhelming majority are those located at or near the top of the results list.

From a marketing perspective it is very beneficial for a retailer to have a link to its website appear at the top, or near the top of ISE or CSE search results pages. In fact, merchants are willing to pay significant amounts of money for their links appear at or near the top of such lists. Typically, an advertising fee arrangement is worked out between a merchant and an ISE or CSE. The ISE or CSE agrees to display the merchant's link at the top of the search results list or in some other prominent position on the search results page, such as a paid listings area or the like, whenever users enter specific search terms. In return, the merchant agrees to pay a specified fee each time a customer selects the merchant's link from the ISE's search results page. Alternatively, some ISEs may have featured links areas or featured partners lists in which merchants pay to be listed apart from and more prominently than the links to non-paying sites. Paying for the traffic generated from prominent placement in a search results list is often referred to as a “Pay-Per-Click” model, because the merchant pays each time a customer mouse-clicks the merchant's link. The merchant is essentially buying customer traffic to its site. Merchants may make pay-per-click arrangements with ISEs, CSEs, and any other website that agrees to display a link to their website in order to generate increased web traffic.

There are a number of problems with the “pay-per-click” model. The first is that there are no provisions for accounting for the quality of the customer traffic sent to the merchant's website. Some customers who click on the merchant's website may be simply browsing with no intention of making a purchase. Others may have decided to buy elsewhere but are merely confirming that they made a sound decision. Some customers may visit the site several times (generating a per-click fee each time) before they commit to a purchase. A more nefarious drawback is that the pay-per-click model is inherently subject to fraud and abuse. Knowing that a merchant is paying for advertising on a “per-click” basis, a competitor may hire personnel or design automated systems for generating excessive click-through traffic to the merchant's web page, tying up resources and driving up the merchant's advertising costs. Industry studies have estimated this click fraud to account for 10% or more of all click revenue collected by ISE's and CSE's. Internet search engines and comparison shopping engines that are paid based on the number times customers click through to the merchant's website have a similar interest in generating excessive click-through totals.

Another drawback of the pay-per-click model is that it is very difficult for merchants to predict what their advertising costs will be relative to the number of additional sales generated by this advertising. If traffic is high but sales are low the advertising cost-per-sale may become excessive. Furthermore, merchants must employ complex software to track both click-through rates (the number of times customers click on the link displayed by the ISE or other advertising web page) and the number of click-throughs that result in product sales in order to avoid advertising losses.

From the customer's point of view the pay-per-click model is disadvantageous as well. Rather then identifying the merchants having the lower price, ISEs or CSEs order their results by the amount the each merchant is willing to pay in per-click advertising fees, with the highest fee listed first. Because of competition, pay-per-click rates are bid up as merchants jockey for more prominent placement. These fees are hidden from the end consumer, which is excluded from the benefits of increased per-click advertising fees and often pays higher end prices as these advertising fees are bid up. In order to find the best deals, customers of general purpose ISE's may have to explore merchants listed much further down the results list, with no guarantee of finding the lowest price unless he or she visits every website on the list. Customers of CSE's are able to organize by price, but industry studies demonstrate the vast majority of users click one of the first three links presented, limiting their exposure to lower priced offers presented further down in a results set. Additionally, CSE and ISE users are typically unaware of the higher pay-per-click rates paid by prominent advertisers on the ISE's and CSE's, and receive no tangible benefits as these rates increase. Further, the only advantage merchants receive from bidding up their pay per click rates is increased prominence; the increased rates don't improve the attractiveness of the merchant's offer.

The current generation of Internet search engines and comparison shopping engines generally improve the on-line shopping experience, provide a mechanism for merchants to improve their on-line presence, and create a marketplace of pay per click advertising rates that benefits the ISE's and CSE's. However, flaws in the pay-per-click advertising model have the potential to distort the process and diminish the efficiency of such systems.

### BRIEF SUMMARY

A system and method of advertising products on an ISE are disclosed. A competitive environment is created in which merchants compete for prominent placement at or near the top of merchant search result listings identifying the merchants offering a particular good or service for sale. Merchants can purchase prominent placement on such lists by outbidding competitors and agreeing to pay an adjustable advertising fee for every completed sale originating with the ISE. A portion of the advertising fee paid by a merchant to the ISE for completed sales may be passed on to the customer as a discount. The additional discount may provide incentives for customers to shop using the ISE as the additional discount will lower the final costs of the product below the prices the merchant is able to charge through other outlets.

A web based ISE includes a web server for generating advertising pages to be displayed by web clients. The advertising pages may be in the form of product search results where the ISE identifies merchants selling a particular product a customer is interested in purchasing and creates a table or list including all of the merchants selling the product along with relevant pricing information, and the like. In order to generate the search results, the CSE includes one or more databases storing merchant product pricing and merchant discount data. A system controller is provided for parsing client requests and pulling merchant product pricing data and merchant discount data from the database in order to populate the search results/advertising pages. The merchants are displayed, along with their corresponding pricing data and merchant discount data, among other relevant information, in an order determined by each merchant's pricing data and discount data. For example, the merchants may be displayed in an order based on each merchant's final customer price. The final customer price may be calculated by subtracting the customer discount provided by the ISE from the merchant's product price.

According to another aspect merchants agree to pay an adjustable advertising fee in order to be prominently listed in the search results on a displayed advertising page. The advertising fee is paid only for completed product sales generated from that advertising display. A corresponding merchant discount is based on a fixed proportion of the adjustable advertising fee as set by the ISE. Over time, the merchant may change the amount of the advertising fee the merchant pays for each completed sale and thereby alter the merchant discount by a corresponding amount. The web based ISE may include an auction bidding service which allows merchants to dynamically bid against one another based on their applicable merchant discounts and posted prices. Merchants having the lowest final price with the merchant discount included will be given the most prominent placement in the product search results when customers perform product searches on the ISE.

An advertising method according to another aspect, an ISE is adapted to display one or more merchants offering a particular product for sale. The method further includes identifying a product price for each of the one or more merchants offering the product for sale. A price-per-sale agreement is entered into with each of the at least one merchants. According to the price-per-sale agreement, each merchant agrees to pay an advertising fee for each completed product sale initiated through the ISE. A price discount is calculated for each merchant. Each merchant's price discount is based on the particular price-per-sale advertising fee separately negotiated by the individual merchant. The method further includes calculating a final price for each merchant by subtracting each merchant's price discount from the merchant's base product price. Once the final price has been calculated for each merchant, the results are displayed in a list ordered according to each merchant's final price. The displayed list may include a link between the ISE and a merchant purchase facility such that a customer desiring to purchase the product from a particular merchant may be directed from the ISE to the merchant's purchase facility.

An advertising method according to the invention may further include gathering data regarding various customer characteristics and maintaining customer profile data for customers who make product purchases through the ISE. Customer characteristic data may include demographic data, geographic data, purchase history data, and the like. Merchants selling products via the CSE may elect to pay different advertising fees for sales to customers having different customer profile characteristics in order to create more targeted advertising programs.

Another aspect of the invention includes a method of providing price discounts to customers using an ISE to locate products and identify merchants selling the products. Such a method includes entering a price-per-sale agreement with at least one merchant in which the merchant agrees to pay an advertising fee for each completed sale of a product to a customer who has been directed to the merchant via the ISE, and offering a portion of the advertising fee to the customer as a price discount. The method may further include establishing a customer discount account and crediting the account by an amount equal to the customer discount when the customer purchases a product from a merchant. Dispersements may be made to the customer when the account balance exceeds a predefined threshold, or at various incremental threshold amounts.

Finally, a method of creating competitive market driven advertising rates is provided. According to this aspect an advertising space is provided where a plurality of merchants selling a common product may place advertisements. A mechanism is provided for directing customers from the advertising space to a sales facility associated with each merchant, so that product sales resulting from customers having been directed from the advertising space to the sales facility of a particular merchant are be attributed to the merchant's advertisement within the advertising space. The method further calls for entering into an adjustable price-per-sale advertising agreement with each of the plurality of merchants. According to such agreements, each merchant agrees to pay a fee for each product sale that can be attributed to the merchant's advertisement in the advertising space. Merchant advertisements are arranged in the advertising space based on the amount of the fee each merchant agrees to pay for each product sale. Merchants may improve the position of their advertisements within the advertising space by either dropping their base price or increasing the amount of the fee they agrees to pay for each sale relative to the fees other merchants agree to pay.

Other systems, methods, features and advantages will be, or will become, apparent to one with skill in the art upon examination of the following figures and detailed description. It is intended that all such additional systems, methods, features and advantages be included within this description, be within the scope of the invention, and be protected by the following claims.

### BRIEF DESCRIPTION OF THE DRAWINGS

FIG. 1 is a block diagram of an ISE and the network environment in which it operates.

FIG. 2 is an ISE product search results page.

FIG. 3 is an ISE product search results page.

FIG. 4 is a flowchart showing a method of implementing product advertising on an ISE.

FIG. 5 is a flowchart showing a method of generating product search results on an ISE.

FIG. 6 is a detailed block diagram of an ISE according to the invention.

### DETAILED DESCRIPTION

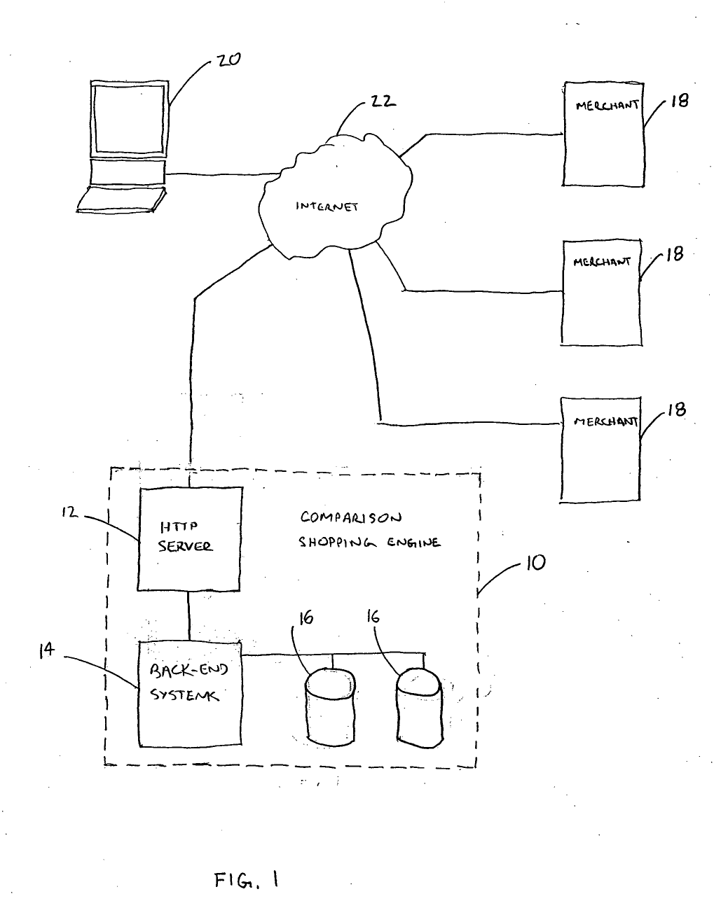

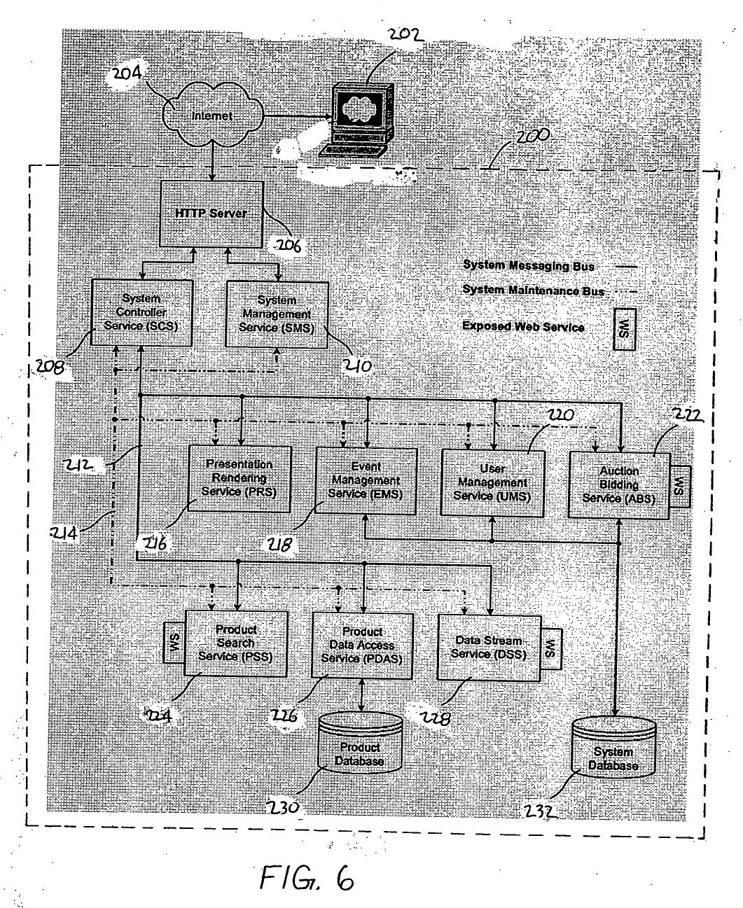

FIG. 1 is a simplified block diagram of an Internet search engine (ISE) 20 and the network environment in which it operates. In addition to the ISE, FIG. 1 also shows a customer computer 20, a plurality of merchant systems 18 and network 22 such as the Internet. The customer computer 20, the merchants 18 and the ISE 10 are connected to and communicate with one another over the network 22. The ISE includes, among other things, a web server 12, and back end systems 14. The web server 12 is provided for generating and serving web pages to web clients such as customer computer 20 and merchant systems 18. The ISE backend systems 14 are provided for processing customer requests and processing merchant transactions. The backend systems include one or more databases 16 for storing product data, pricing and discount data, customer data, and the like. A more detailed discussion of the ISE backend systems and how they operate will be provided in connection with FIG. 6 below.

Merchant systems 18 provide product price and discount information to the ISE. Product information includes the identity (make and model) of products the merchant desires to sell. Price information include the base price the merchant is charging for the products, applicable sales tax, shipping costs, and the like.

A Customer 20 may access the ISE to identify products the customer wishes to buy, and merchants offering the products for sale. The ISE returns search results web pages that may be displayed by the customer's web browser. The search results may include a results list or table identifying the various merchants offering a desired product, along with merchant pricing information including the base price, incidental charges, discounts, and other information.

The ISE web server 12 may be adapted to serve different web pages to different clients. For example, whereas the web server 12 may send search query and results pages to customers 20, the web server 12 may send merchant interface pages to merchant systems 18. Merchant interface pages may include provisions for merchants to submit product, pricing and discount information to the ISE. The merchant interface pages may include provisions for merchants to change product and pricing data substantially in real time so that merchants may quickly respond to market forces and make pricing decisions in response to events as they occur.

Whether customer or merchant oriented web pages are served to particular clients may be determined by user ID and passwords entered in an initial login page served to all clients accessing the ISE, or by some other access control mechanism. User names, passwords, and the like may be stored in a database 16 associated with the ISE 10.

Among the features of the ISE are the manner in which search results are listed on the search results pages and the competitive manner in which merchants negotiate advertising fees in exchange for prominent placement on the search results pages. The key to both of these features is a price-per-sale (PPS) method of charging for advertising. According to an aspect of the invention, a merchant 18 may pay a fee to have its name, product, and pricing information prominently displayed at or near the top of product search results lists contained in the search results pages served to customers in response to customer search queries containing specific words, phrases, products, or the like. However, unlike the price-per-click model employed by other search engines and comparison shopping engines, merchants in the present model need only pay for completed sales. The price-per-sale (PPS) model provides significant advantages for both merchants and customers alike.

The price-per-sale method of charging for advertising impacts the order in which merchants are listed in the product search results generated in response to product queries. A merchant's position in a search results list is determined by a final customer price. Merchants having the lowest final customer price for a particular product are displayed at the top of the results list. Merchants whose final prices are relatively high are displayed further down the list. The final customer price includes, among other things, the merchant's base price, incidental charges such as sales tax and shipping charges, and a customer discount derived from the price-per-sale fee each merchant independently negotiates with the ISE.

Typically, the customer discount will be a fixed portion of the price-per-sale advertising fee. For example, the ISE may establish the customer discount as 50% of the agreed upon price-per-sale advertising fee. In this case, half of the per-sale advertising fee collected on each sale will be returned to the customer in the form of a price discount. Thus, a higher price-per-sale advertising fee paid by the merchant will result in a larger customer discount paid to the customer, and therefore, a lower final customer price. A lower final customer price has the potential to improve the position in which the merchant is listed in the product search results list and the attractiveness of the merchant's offer to the customer. Therefore, each merchant has an incentive to pay a higher per-sale advertising fee to improve its position in the search results. Furthermore, since the higher per-sale advertising fee results in a lower final customer cost, increasing the per-sale advertising fee has the potential for attracting additional sales.

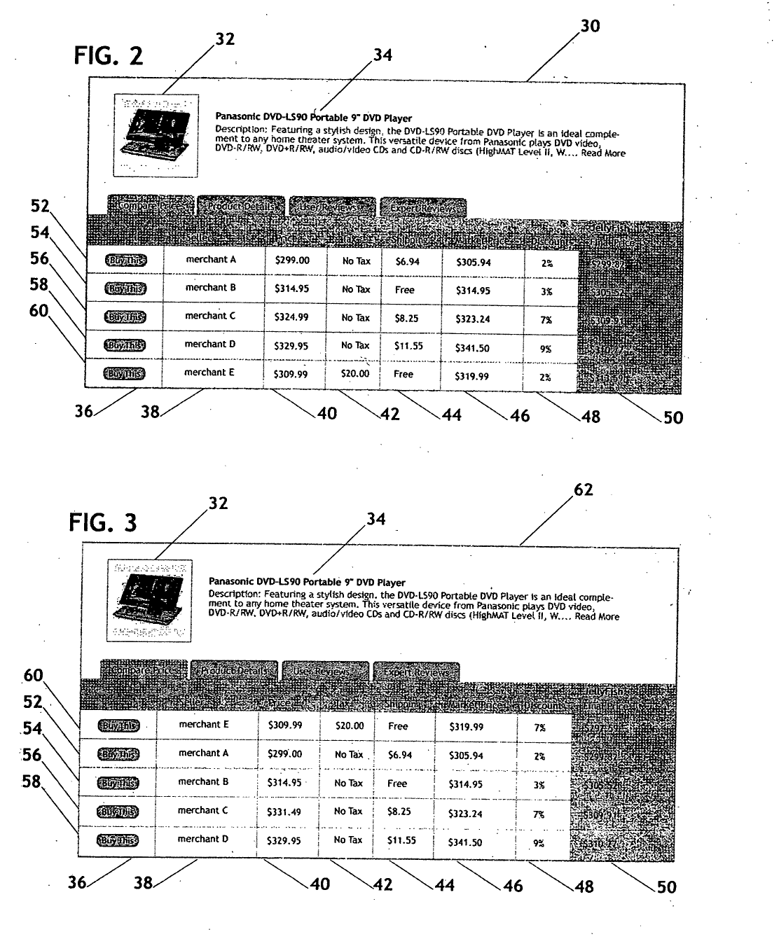

FIGS. 2 and 3 show product search result pages 30, 62 respectively. The two results pages 30, 62 illustrate how a merchant may improve its position in the product search results list by agreeing to pay a higher price-per-sale advertising fee. The basic structure of the two results pages 30, 62 is substantially the same. Features common to both results pages 30, 60 have been given like reference numbers. Both results pages include a product display area 32 and a product description area 34. The product displayed in the product display area 32 and described in the product description area 34 represents a product a customer is interested in purchasing. Arriving at the particular product of interest may be the result of a winnowing process in which the customer first identifies a particular category of products he or she is interested in. The ISE may return a list of all of the various products available in the particular product class, or may return several sub-classes of products from which the customer may choose. This process may continue until the customer reaches a level where he or she has no choice but to select a specific product make and model.

The results pages 30, 62 represent the results of a specific product selection. Merchant pricing and discount data displayed in the results pages relate to merchant offerings for identical products. The product search results are displayed in a matrix or table form in which each row contains pricing data relating to a different merchant's product offering. In the examples shown in FIGS. 2 and 3 there are five merchants offering the same product. Thus, each results page includes a display matrix having five rows. Row 52 corresponds to a first merchant, Merchant A; row 54 correspond to a Merchant B; row 56 Merchant C; row 58 Merchant D; and row 60 Merchant E.

The results matrix is further divided into columns for displaying details of each merchant's offer. In general the ISE does not execute sales but rather directs customers to merchant websites where the sales transactions are consummated. Column 36 provides hypertext links from the results page directly to each merchant's web site. A customer may purchase the product from the merchant's website. Column 38 identifies the various merchants offering the particular products. A merchant name or logo, or other branding information may be displayed in column 38 so that customers may readily identify the source of the various product offers. Column 40 shows the base price at which each merchant is offering the product. Column 42 displays applicable sales tax. Column 44 shipping charges. And column 46 shows a total market price that includes the base price 40, applicable taxes 42 and shipping charges 44. Column 48 shows the customer discount applicable to purchases made from each merchant. Recall that the amount of the customer discount is based on the price-per-sale advertising fee negotiated between each merchant and the ISE. Each merchant independently determines the amount it is willing to pay for advertising for each sale generated through the ISE. Finally, column 50 represents a final customer price. The final customer price represents the total cost to the customer for purchasing a product from a particular merchant after the customer discount 48 has been applied.

Referring solely to FIG. 2, we see that the merchants are listed in order of increasing final customer price 50. Merchant A, the merchant offering the lowest final price at $299.82 occupies the top row 52. Merchant E, having the highest final price $313.59 is listed in the bottom row 60. Merchants B, C and D having final customer prices between $299.82 and $315.59 are listed in succession in rows 54, 56, 58 between Merchant A and Merchant E. It should be noted that Merchant E is listed last despite the fact that Merchants B, C, and D offer the same product at higher base prices than Merchant E. Even factoring in sales tax and shipping costs, Merchant E still has a lower market price than Merchants C and D. Nonetheless, after the customer discounts are applied Merchant E's final price exceeds all others. In order to improve its position in the list, Merchant E has but two choices: lower its base price or increase the size of the customer discount.

In many cases, lowering the base price will be the less attractive option because setting a different base price may conflict with prices set for other sales channels. For example, although a merchant may want to lower its price to attract more customers from the CSE, it may not want to lower prices for customers who have arrived at its website, or visited its brick and mortar stores on their own, or as a result of other advertising efforts. In other words, the merchant may not wish to reprice its entire inventory for what may prove to be a transitory improvement in its position on an ISE product search results list. Thus, the most efficient way for the merchant to improve its position in the ISE product search results page and the pricing of its offer is to increase the size of its customer discount by agreeing to pay a higher price-per-sale advertising fee to the ISE. The ability to manipulate the final product price by altering the per-sale advertising fee rather than the merchant's base price creates a site specific pricing mechanism that does not affect the merchant's prices in other sales channels.

Above we used the example in which the customer discount was set to 50% of the per-sale advertising fee. In the results page 30, the customer discount associated with merchant E is 2% of the market price. With the customer discount equal to 50% of the per-sale advertising fee, a 2% customer discount corresponds to a 4% per-sale advertising. Increasing the price-per-sale advertising fee will increase the customer discount and thereby lower the final price. If the change in the final price is sufficiently large it may improve Merchant E's position in the product search results list.

Analyzing search results page 30, Merchant E must improve its final price by at least $13.77 to beat Merchant A's final price of $299.82 and claim the top position on the product search results list. The search results page 62 in FIG. 3 shows the product search results list after Merchant E agrees to raise its price-per-sale advertising fee to 14% of the market price. Again, assuming a customer discount equal to 50% of the price-per-sale advertising fee, a 14% per-sale advertising fee corresponds to a 7% customer discount. Applying a 7% customer discount to Merchant E's $319.99 market price results in a final customer price of $297.59, $2.23 lower than Merchant A's $299.82 final price. In the product search results page 62 of FIG. 3, Merchant E has claimed the top spot on the merchant list by delivering the lowest final price. In this example none of the other merchants have changed their discount, so their relative positions remain unchanged. Because of Merchant E's vault to the top of the list, however each other merchant's position is shifted down by one to make room for Merchant E.

In a dynamic live market all of the merchants may continue vying against one another to claim the best spots on the product search results lists generated in response to product queries for the products they sell. A particular advantage of the price-per-sale advertising model integrated into a marketplace is that competitors will quickly bid up advertising fees to their fair market value. Merchants will attempt to outbid their competitors in order to retain the most prominent place on the search results list so long as the price-per-sale advertising fee can be justified. If a particular discount cuts too deep into profit margins, the merchant may settle for a less desirable position on the product search results list. Alternatively, merchants may decide to pay any price necessary to maintain a position at the top of the product search results lists for any given product. In fact, a merchant could issue a standing order to always outbid the next highest bidder in order to preserve the top position in a product search results list. Another advantage to this type of market driven advertising is that at least a portion of the optimized advertising fees accrue to the customer's benefit, and likewise benefit the merchant by improving the attractiveness of their offer. Both customers and merchants have incentives for using the ISE to buy and sell products.

Returning to the results pages 30, 62, when a customer decides to purchase a product from one of the merchants listed on the search results page, the customer may simply click on or otherwise execute the hypertext link pointing to the selected merchant's website to purchase the product. When the customer selects a link to one of the displayed merchant websites, the ISE logs the transaction and redirects the customer computer to the designated merchant web site. The redirect URL includes parameters identifying the ISE as the source of the transaction, the customer, the product, the price, and the discount. Other parameters may also be included if desired. When the customer completes a purchase at the merchant's site, the merchant site initiates an internet communication to the ISE. The communication from the merchant to the ISE may also include parameters identifying the customer, the transaction, the product, the price, the discount, the transaction date, time and so forth. Based on these data exchanges the ISE may verify which customer redirects resulted in product sales and may log the price-per-sale advertising fees associated with the transaction, and the corresponding discount due to the customer.

Since the customer discount is to be paid out of the proceeds from the price-per-sale advertising fee, the ISE pays the discount to the customer. The ISE may create customer accounts which are credited with the appropriate customer discounts each time customers purchase products through the ISE. The ISE may determine when and how the discounts are reimbursed to customers. For example, the ISE may withhold the discount until the price-per-sale advertising fee associated with a sale has been collected from the merchants. Payment to the ISE may itself be delayed until an open returns period expires (typically 90 days) or until some other milestone is reached indicating that the sale is final. For efficiency, the ISE may decide to disperse accumulated discounts in incremental amounts. For example, the ISE may only disperse accumulated discounts in $10 increments. In this case a disbursement would not be made to a customer until the balance in the customer's account exceeds $10. If the customers account balance is between $10 and $20, a $10 check may be sent to the customer. The balance remains in the account until additional purchases drive the account balance back over the $10 threshold. If, due to a large purchase a customer's account is above some multiple of $10, the ISE may disperse an amount equal to the highest multiple of $10, with the remainder remaining in the account.

The price-per-sale model of paying for preferential placement on product search results pages requires merchants to report product sales back to the ISE. Every sale, from every merchant, to every customer, the amount of each sale, the amount of each discount, in short every aspect of each transaction, is reported back to the ISE so that the ISE may properly bill merchants for the applicable price-per-sale advertising fee and reimburse customers the proper discount amounts. With such data at its disposal, the ISE may serve as a vast repository of sales and marketing data. In addition to the sales transaction data received from the merchants, the ISE may also gather financial and demographic information from customers when they sign up to use the ISE. Such customer data combined with the sales transaction data may be used to great advantage by sales and marketing personnel trying to develop more targeted advertising programs.

In a first example, a merchant may want to improve its market presence among a specific customer demographic, for example customers between the ages of 18-24. The ISE may require customers to enter their age when they sign up for the service. Based on their login information, the ISE will know which customers are accessing the ISE, and it will know which customers fall into 18-24 year old category. The merchant may opt to pay a greater per-sale advertising fee when customers in this group purchase products. Paying a greater per-sale advertising fee for sales to customers in this demographic range will ensure that the merchant occupies a prominent spot in the search results lists and displays more attractive pricing when 18-24 year olds search for products. Similarly, the merchant may opt to pay a lower per-sale fee to customers outside the targeted demographic to otherwise limit advertising expenditures.

The possibilities for fine tuning targeted advertising campaigns are substantially limitless. Another example of a highly targeted campaign may include providing greater discounts to customers whose previous purchases were made from a competitor. Similarly, greater discounts may be offered based on geographic location in order to enhance a retailer's visibility in a certain region. Smaller discounts may be provided to regular customers whose brand loyalty is not in doubt. Variable discounts may be created based on the time of day. A merchant may want to ensure prominent placement in product search results lists during times of the day known to be heavy on-line shopping periods, such as during the lunch time or late evening hours, and so forth. In general, the advertising pricing model employed by the present invention allows unequaled flexibility for marketers to design targeted campaigns to maximize a merchant's exposure to groups of customers that matter most.

Sales data may also be used to assist customers in making decisions on which products to buy and where to buy them. In one situation the ISE may track all products sales resulting from a particular search query. For example the ISE may track all sales that followed an initial product search query for “digital cameras”. The next time a customer enters the search term “digital cameras” the search results may include a multitude of different models of digital cameras. In order to help the customer select a particular model the ISE may include the percentage of customers who bought each model of camera after entering the search term “digital camera.” Thus, the customer may get an idea of which models were most popular with other customers who made similar purchases. Similar purchase history data may be provided regarding the merchants from whom other customers purchased their products. Again such information may help customers determine who are the most reliable and best liked merchants offering the desired products.

The price-per-sale advertising model employed by the ISE may be extended to a more general cost per action (CPA) model in which a merchant pays a fee to the ISE each time a customer performs a desired activity. The ISE may share a portion of the fee paid by the merchant to the customer in order to provide an incentive for the customer in order to perform the desired act. As an example, a merchant may want to send a targeted e-mail campaign to a select group of customers. Obviously, the merchant would like to have as many customers as possible open and read the targeted e-mail message. The merchant may prepare the campaign in conjunction with the ISE, identifying appropriate target customers from the ISE's accumulated transaction data. The merchant agrees to pay the ISE a set fee each time a customer performs a specified act, such as opening the e-mail message, responding to the e-mail message, filling out a customer survey contained in the e-mail, or some other monitorable activity related to the e-mail campaign. The ISE shares a fixed portion of the cost per action with the customer when the customer performs the desired activity.

The vast database of sales transaction data accumulated by the ISE may be used to focus the e-mail campaign or some other direct contact marketing campaign to further enhance the effectiveness of the campaign. For example, an advertising campaign may be directed toward advertising an accessory for another product. The direct contact campaign may be directed toward all customers who have recently purchased the first product and therefore may be more likely to be interested in the accessory. By limiting the campaign to customers who have recently purchased the first product, the cost of the campaign is reduced, but the chances of contacting an interested customer are greatly improved.

Offering a reward to customers who perform some activity related to the campaign further increases the chance that contacted customers will pay attention to the campaign. The designated activity may be designed such that it requires the customer to fully comprehend the nature of the campaign offer. For example, customers who have recently purchased a digital camera may be targeted by a campaign to sell photo quality printers. ISE customers who have purchased digital cameras and who have agreed to receive marketing e-mails may be targeted by the campaign. The campaign may comprise e-mailing a product survey to each targeted customer. The campaign may promise to pay $10.00 to each customer who fills out and returns the customer survey. Advertisements for the photo quality printer may be embedded in the survey. Enticing customers to take the survey guarantees the customers will at least see the embedded ads. Questions within the survey may even require the customer to look at or analyze the embedded ad, further ensuring significant cognitive penetration.

A targeted e-mail campaign such as that described above is only one example of the types of campaigns that may be created using a cost-per-action payment model for ensuring desired ad penetration. Another example may include paying an incentive to customers for contacting a merchant listed in a particular search results set, following a particular hypertext link, or some similar action. Sharing the cost per action fee with the customers who are being asked to perform the particular action significantly improves the odds that at least some customers will perform the desired activity.

The ISE acts as an intermediary between customers and multiple willing sellers. The sellers essentially bid against one another in a reverse auction in which multiple sellers compete for each customer. This arrangement opens many opportunities for providing additional services favorable to both customers and merchants. Under traditional sales methods, including those described above, merchant's publish their prices and customers determine whether they want to purchase the products at the published price. If the prices are too high, customers may opt to wait in hopes that one or more merchants may offer a discounted sale price in the future to move inventory. According to a feature of the present invention, a customer may request that the ISE contact the customer if the final price of a particular product drops below some customer defined threshold price. Thus, as the various merchants vie with one another for top billing on the ISE product search results lists distributed to customers in response to queries for the product, the customer will be alerted if any merchant provides a sufficient discount to lower the final customer price below the customer set threshold. Upon being alerted to the new price, the customer may decide to buy the product at the reduced price.

On the opposite side of the transaction, the ISE may publish the customer defined price alert thresholds to the various merchants selling the particular products to which the price alerts relate. The price alert threshold information indicates to merchants that there is a willing buyer standing ready to purchase the product at the established threshold price. A merchant may decide that the customer established threshold price is acceptable and may adjust its negotiated price-per-sale advertising fee accordingly, so that when the resulting customer discount is applied to the base price, the final customer price is below the customer threshold price. Once the merchant has lowered the final customer price below the customer established threshold, the customer may purchase the product from the merchant.

In an alternative arrangement, the ISE may be adapted to execute a transaction on behalf of a customer when a merchant meets the customer established threshold price. In this case, the ISE begins to take on the characteristics of a retail exchange, matching buyers and sellers in a fluid market that automatically sets the price of products to that at which buyers are willing to buy and sellers are willing to sell.

As a further effort to enhance sales and provide additional guidance to future customers, the customers who have already purchased products through the ISE may be recruited to act as product reviewers or merchant references to comment on their experiences with the products they have purchased in the past and the various merchants they dealt with which making their purchases. Customers considering buying the same products as a customer reviewer, or considering buying from the same merchant as a merchant reference may contact the product reviewer or merchant reference to gain insight into the product reviewer's or merchant reference's experience with the subject product or merchant. Past buyers may be enticed to become product reviewers or merchant references by offering rewards to customers who act in such capacities. The incentives could range from monetary payments made from the proceeds of per-sale advertising fees, increased customer discounts on future purchases, upgrading the product, reviewer's or merchant reference's membership to a higher tier in which larger discounts are offered to customers, and so forth. To ensure quality feedback from the designated product reviewers and merchant references, the rewards for serving as a product reviewer or merchant reference may be withheld pending an evaluation from the customer or customers who contact the product reviewer or merchant reference seeking advice. Thus, the customers using the ISE may form an on-line buying community, helping to guide the purchases of other customers, and providing feedback on the value of such guidance. All through the process customers may be provided with incentives to take an active role in the buying community, be it receiving marketing e-mails, filling out surveys, rating products and merchants or rating the customers who are rating products and merchants. The incentives for taking an active role may all be derived from the price-per-sale fees paid by the merchants selling products through the ISE. Such a system has more integrity than current on-line marketplaces that include product review and the like, since the present system can validate that the reviewers are actual purchasers who have in fact sampled the various products and purchased from the various merchants.

Separate on-line communities or buying groups may be established among like minded customers, or customers belonging to outside organizations. The members of such buying groups may collectively agree to donate their customer discounts to a particular cause or charitable organization. When they purchase products through the ISE, the ISE may agree to match a portion of such donations in order to increase the impact of each customer's contribution. In exchange, the organization receiving the donations may agree to promote the ISE to its members. In this way all parties involved benefit from each transaction. Merchants benefit by making additional sales, customers benefit by having an efficient mechanism for donating their price discounts to an organization they support. The organization receiving the donations benefits from the extra donations, and the ISE benefits from the promotional efforts of the organization on its behalf. In short, the currency created by the price-per-sale advertising fee charged to merchants and the discounts paid back to customers may be put to many different uses which improve and enliven the on-line shopping experience.

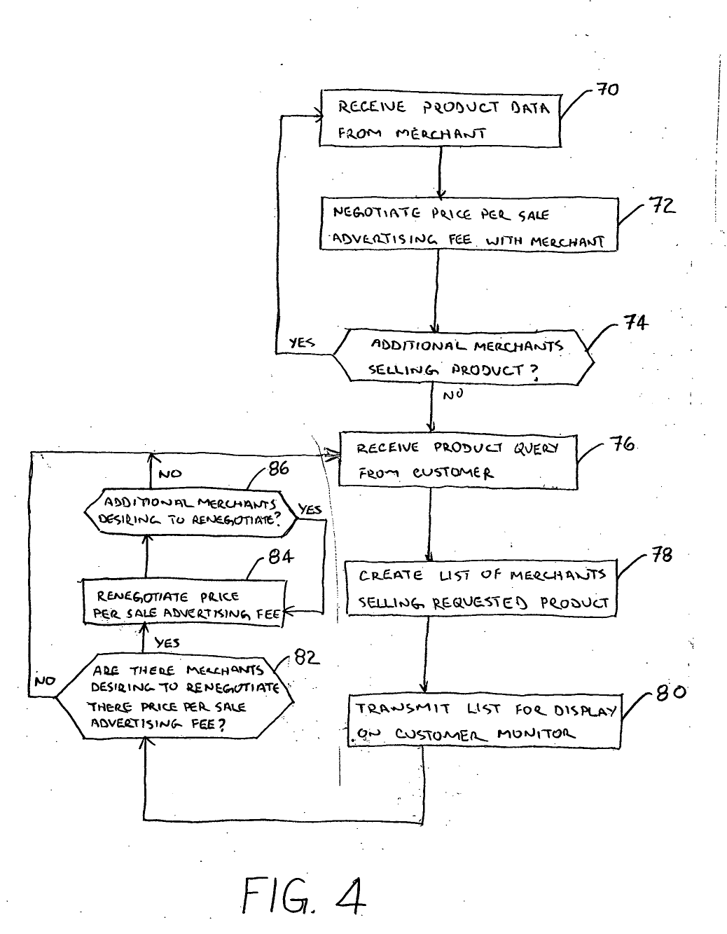

FIG. 4 is a flowchart showing a method of implementing product advertising on an ISE according to the invention. The method begins at 70 where the ISE receives product data from a merchant about a particular product. In addition to data identifying the merchant, the product data may include a product ID, a merchant price, sales tax and shipping costs, and the like. At 72 the merchant negotiates a price-per-sale advertising fee with the ISE. Under this arrangement the merchant pays the negotiated fee to the ISE only for completed sales to customers directed to the merchant's website from the ISE. At 74 the ISE determines whether there are additional merchants desiring to sell the same product. If yes, processing returns to 70 and product data are received from another merchant. The other merchant negotiates a price-per-sale advertising fee at 72, and the ISE again determines whether there are additional merchants, and so forth. If the determination is made at 74 that there are no additional merchants selling the product, the ISE waits to receive a query from a customer interested in buying the product at 76. Once a customer query for the product is received the ISE generates the search results list at 78. The search results include all of the merchants known to the ISE selling the product. The ISE sends the results list to the customer who submitted the query over the Internet at 80. The results may be displayed on the customer's computer monitor or some other display device. At 82 the ISE determines whether a merchant wishes to renegotiate the price-per-sale advertising fee it pays to improve its position in the results list in response to future customer queries regarding the product. If so, the merchant renegotiates the fee at 84. At 86 the ISE determines whether there are additional merchants desiring to renegotiate their price-per-sale advertising fee. If so, the process returns to 84 and the next merchant renegotiates the price-per-sale fee, and so on. If at 82 there are no merchants desiring to renegotiate the price-per-sale advertising fee or if at 86 there are no additional merchants desiring to renegotiate their price-per-sale advertising fees the method moves back to 76 and the ISE again waits to receive another customer query for the product.

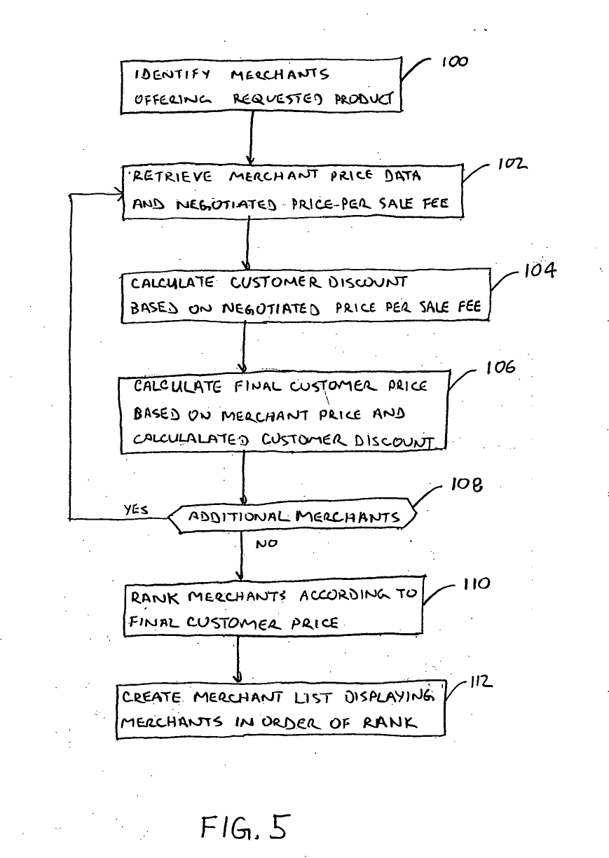

FIG. 5 is a more in-depth flow chart expanding on the process of generating the product search results listing the merchants selling a product in response to a user query. At 100 the ISE determines which merchants offer the desired product. For each merchant the ISE retrieves the merchant's price data and its negotiated price-per-sale advertising fee at 102. At 104 the ISE calculates a customer discount based on the merchant's negotiated price-per-sale advertising fee. A final price is calculated at 106 by applying the customer discount to the merchant price data. At 108 a determination is made whether there are any additional merchants offering the product. If so, the process returns to 102 where the ISE retrieves price data and the price-per-sale advertising fee negotiated by the next merchant. The ISE calculates the customer discount and final price for the next merchant, and so on. If there are no additional merchants at 108 whose data must be retrieved and discounts and final prices calculated, then the ISE moves on to 110 where the merchants are ranked in order of the final price calculated for each merchant. Finally, a list is generated at 112 where the merchants are displayed in rank order along with their associated pricing information, discount, final price, and so forth. The list generated at 112 comprises the product search results that may be transmitted to a customer's home computer and displayed for the customer.

FIG. 6 shows a more detailed block diagram of a comparison shopping engine 200 according to the invention. A remote user such as a customer shopping on the ISE or an agent of a merchant interfacing with the ISE to provide product and price data or to negotiate price-per-sale advertising fees, interacts with the ISE via a web enabled device 202 over the Internet 204. A web enabled device may be a personal computer, a personal digital assistant (PDA), a cell phone or any other device capable of utilizing IP/TCP protocols or other Internet working technologies to access and interact with an HTTP or other network server. The web enabled device 202 typically includes a web browser that provides a graphical interface for displaying web pages over the Internet. The web browser manages the rendering of web pages on the web enabled device's display and manages user inputs and commands and directing communications with various HTTP servers over the Internet.

The ISE 200 includes an HTTP server 206 and a plurality of backend systems supporting communications between the HTTP server 208 and web enabled devices 202. The backend systems include a system controller service (SCS) 208 and a system management service 210. The system controller service 208 communicates with additional backend systems via a system messaging bus 212, and the system management control service 210 communicates with additional backend systems via a system maintenance bus 214. Additional backend systems include a presentation rendering service (PRS) 216; an event management service (EMS) 218; a user management system (UMS) 220; an auction boding service (ABS) 222; a product search service 224; a product data access service 226; and a data stream service 228. The ISE further includes a product database 230 and a system database 232.

The web enabled device 202 interacts with the HTTP server 206 by sending HTTP requests and receiving HTTP responses. Upon receiving a request, the HTTP Server 206 forwards the request to the System Controller Service 208 or the System Management Service 210, depending on the type of request. All business interactions between a user utilizing a Web Enabled Device 202 and the ISE are performed via requests and responses routed through the System Controller Service 208. All system management related requests are performed via requests and responses routed through the System Management Service 17.

The System Controller Service 208 orchestrates the actions of the other services, PRS 216, EMS 218, UMS 220, ABS 22, and PSS 224, to satisfy user requests and to generate a response. The System Messaging Bus 214, provides an asynchronous communication mechanism between the services. The System Controller Service 208 extracts information from requests received from the web enabled device 202 to determine what sequence of actions is required to respond to the requests, and which other services 216, 218, 220, 222 and 224 must be invoked to generate the appropriate response. On determination of a response strategy, the SCS 208 sends messages to the various services 216, 218, 220, 222 and 224 to initiate the appropriate actions and to generate the response. Some of the types of activities may include interacting with the User Management Service 220 to enable registration and login of users, routing search requests to the Product Search Service 224, and so forth. A response to an HTTP request is complete when the System Controller Service 208 receives a message from the Presentation Rendering Service 8. The response is then returned to the HTTP Server 206 for return to the Web Enabled Device 1.

The various services 216, 218, 220, 222, 224, 226 and 228 in the system provide different aspects of the overall system functionality. The functions that each service performs, and the manner in which their actions are orchestrated define the business functions the system is capable of performing. The Presentation Rendering Service 216 supports rendering formats for displaying information such as product search results pages and the like on various end user device types, including regular computer based web browsers and hand-held devices such as PDAs and cellphones. The Presentation Rendering Service 216 renders the appropriate screen format and language(s) for the end user device by utilizing a meta-model to generate content formats. It also generates and encodes web page URLs and interacts with the User Management Service 220 to retrieve defined user profiles for generating custom views and layouts for different users.

The Event Management Service 218 provides generic capabilities for managing all system events driven by user interaction or data feeds. The EMS 218, includes an event validation and alerting capability for event state sequences. A pending cash back event is an example of a user triggered event. A pending cashback event is triggered whenever a user decides to make a purchase. All events will have a type, a duration and one or more resultant action sequences types depending on how the event or alert terminates. Based on its role of controlling the actions taken in response to events and alerts, EMS 218 plays the role of an independent, but secondary System Controller Service 208. The Event Management Service 218 interacts with the System Database 15 to persist and retrieve events and alerts.

The User Management Service 220 provides management and information retrieval functions for maintaining information about users and their roles. For example, users may occupy the roles of customer, merchant, affiliate, or system administrator and the like. These roles help drive the actions that the System Controller Service 208 orchestrates. Key functions of the User Management Service 208 include providing a user registration capability for new users when they wish to register a new account, providing a secure login mechanism for registered users, and for generating various account management reports and controls for users. For example, users may want to be able to check on the status of a pending payment, along with different views of their payment histories. Users may also want to see the status of payments for referrals. The user management service 220 may also provide are a user profile mechanism so that customers and merchandisers can define different default settings for content display and searches; a role-based mechanism for assigning rights to users based on their role; and a tracking function for tracking user history patterns and providing the ability to query such patterns and the like. The User Management Service 220 utilizes the System Database 232 to persist and manage user information.

The Auction Bidding Service 222 allows merchants to manage their product information and discount values for individual products or groups of products. Since product search results are displayed sorted by final are cost to the user, merchants must to be able to dynamically bid and adjust the discount value applied to some or all of their products if they want their product to be at or near the top of the search results pages. The Auction Bidding Service 222 provides merchants with the ability to list, filter and display their particular products, allows them to change the discount values for any and all of their products, lets them specify an alert on a particular product or group of products if the price on the product crosses a specified boundary, and tracks their activity patterns in changing discounts and defining alerts. The Auction Bidding Service 222 also interacts with the Event Management Service 218 on completion of a change in a discount value for a product. A web service interface is provided for auction bidding service that automatically exposes the service interface to merchants to allow merchant to perform any of the above functions via an external system.

The Product Search Service 224 provides a text indexing and search capability by matching search query terms against search indices. Key functions of the Product Search Service 224 are to provide indexing of the product information stored in the Product Database 230, provide fast and flexible searching of key word indices to search for keywords entered by a user, interacting with the Product Data Access Service 226 in order to retrieve data for the indices found through a search, and to provide user customizable search capabilities that correspond with a user's profile where the user profile define the manner in which the search matching should be performed. The Product Search Service 224 also provides the ability to selectively reindex portions of the index set when new data is added to the product database and formats response data in an XML form corresponding to the system data model. A web service interface is also provided that exposes the service interface to merchants to allow merchants to perform any of the above functions via an external system.

The Product Data Access Service 226 provides an abstraction layer between all the other services and the Product Database 230. This abstraction layer provide the other services a system view of the product data through a common system data model and provides a common set of commands that the other services can utilize for submitting queries, updates, and the insertion of additional product information. The Product Data Access Service 226 also includes a high speed cache for all product data to ensure very fast read access in response to searches completed by the Product Search Service 224.

The Data Stream Service 226 is the mechanism through which product related data are brought into the system. Different types of data streams may be fed into the system. The different types of data streams may have different types of sources as well. When bringing in a data stream, the Data Stream Service 16 maps the syntax and semantics of the data stream to correspond to a common internal model and applies validation rules against the incoming data to ensure the core product data stored in the Product Database 14 remains of the highest quality. The data stream service 228 generates exception reports for product and price values that don't validate in a record set. The data stream service 228 creates an information for information that is change set to be inserted/updated and sends messages to the other services to identify actions that the other services must perform, based on the type of information being imported. For example, if a merchant sends product information, the Product Search Service 227 must know to update at least some of its indices. Or, if a retailer sends completed sales information, the Event Manager Service 218 must learn that some of its pending events have been completed so that it can take appropriate actions based on each event type. A web service interface may be provided for the data stream service 228 that exposes the service interface merchants so that merchants may perform any of the above functions via an external system.

The System Management Service 210 provides various management and monitoring functions. The system management service 210 interacts with all of the other services 208, 216, 218, 220, 222, 224 226 and 228 via the System Maintenance Bus 24. The System Management Service 210 provides centralized logging for all services, monitors the health of each system service and the databases 14, 15. The system management service 210 sends alerts to system administrators when ever configurable level threshold events are exceeded, and displays various status reports. The System Management Service 210 also provides a start up, restart, and shutdown capabilities for the entire system or for individual services.

While various embodiments of the invention have been described, it will be apparent to those of ordinary skill in the art that many more embodiments and implementations are possible within the scope of the invention. Accordingly, the invention is not to be restricted except in light of the attached claims and their equivalents.

We claim:

1. An Internet search engine comprising:
a web server for generating search results pages to be displayed by web clients;
one or more databases storing merchant product pricing and merchant discount data; and
a system controller for parsing client requests and pulling merchant product pricing data and merchant discount data from the database for populating the search results pages, where merchant pricing data and merchant discount data for a plurality of merchants are displayed on a search results page in an order determined by each merchant's pricing data and discount data.

2. The Internet search engine of claim 1 where merchant product pricing relates to at least one of tangible goods or services offered by merchants.

3. The Internet search engine of claim 1 where the order in which merchant pricing and discount data are displayed on the advertising page is based on a final customer price calculated by subtracting a customer discount from a merchant product price.

4. The Internet search engine of claim 3 where merchants agree to pay an adjustable amount advertising fee to have the merchant's pricing data and merchant discount data displayed on the advertising page.

5. The Internet search engine of claim 4 where the customer discount is based on a fixed proportion of the adjustable amount advertising fee.

6. The Internet search engine of claim 5 further comprising an auction bidding service where a merchant may change the amount of the adjustable amount advertising fee.

7. The Internet search engine of claim 3 further comprising an auction bidding service for allowing merchants to dynamically bid for desirable placement on the advertising pages generated for display by web clients by altering the amount of the adjustable amount advertising fee.

8. The Internet search engine of claim 1 where the advertising pages generated by the web server for display by web clients include at least one hyperlink to a merchant web site where a customer may purchase a product.

9. The Internet search engine of claim 8 where the system controller is configured to charge a merchant an advertising fee in response to each product sale to a customer who executes a hypertext link from the advertising page to the merchant web site.

10. The Internet search engine of claim 9 further comprising a database for logging transactions when a customer executes a hypertext link from the advertising page to the merchant website.

11. An advertising method comprising:
providing a comparison shopping engine adapted to display one or more merchants offering a particular product for sale;
identifying a product price for each of the one or more merchants offering the product for sale;
entering a price-per-sale agreement with each of the at least one merchants, where each merchant agrees to pay an advertising fee for each completed product sale initiated through the comparison shopping engine;
calculating a price discount for each merchant based on the particular price-per-sale advertising fee separately agreed to by each merchant;
calculating a final price for each merchant by subtracting the price discount calculated for each merchant from each merchant's product price; and
displaying the one or more merchants offering the particular product for sale in a list ordered according to the final product price calculated for each of the at least one merchants.

12. The method of advertising of claim 11 wherein the particular product offered by the merchant comprises at least one of a tangible good or service.

13. The advertising method of claim 11 further comprising providing a link between the comparison shopping engine and a merchant purchase facility such that by selecting the link a customer desiring to purchase the product from a merchant is directed from the comparison shopping engine to the merchant's purchase facility.

14. The advertising method of claim 13 where the merchant charges customers the merchant price for the product and the comparison shopping engine pays the price discount to the customer.

15. The advertising method of claim 14 further comprising maintaining a customer discount account and crediting the customer discount account by an amount equal to the product discount amount.

16. The advertising method of claim 15 further comprising reimbursing a customer from the customer discount account when an account balance exceeds a pre-defined threshold.

17. The advertising method of claim 15 further comprising applying a customer's customer account balance toward a purchase of additional products from merchants advertising products on the comparison shopping engine.

18. The method of advertising of claim 13 further comprising providing a dynamic bidding system and accepting bids from individual merchants in which the individual merchants adjust the advertising fees the individual merchants agree to pay for each product sale in order to influence the individual merchants' position on the list displaying the individual merchants offering the product for sale.

19. The advertising method of claim 18 further comprising gathering customer characteristics and maintaining customer profile data for customers making product purchases through the comparison shopping engine.

20. The advertising method of claim 19 wherein the customer profile data include at least one of: demographic data; geographic data; or purchase history data.

21. The advertising method of claim 20 further comprising providing a merchant the opportunity to pay different advertising fees for sales to customers having different customer profile characteristics.

22. the advertising method of claim 11 further comprising aggregating customer purchase data for customers making product purchases through the comparison shopping engine and customer purchase data.

23. A method of providing price discounts to customers using a comparison shopping engine to locate products, the method comprising:
entering a price-per-sale agreement with at least one merchant in which the merchant agrees to pay an advertising fee for each completed sale of a product to a customer who has been directed to the merchant via the comparison shopping engine; and
offering a portion of the advertising fee to a customer as a price discount when the customer who has been directed to the merchant by the comparison shopping engine purchases the product from the merchant.

24. The method of claim 23 wherein the products comprise at least one of tangible goods or services.

25. The method of claim 23, further comprising establishing a customer discount account and crediting the customer discount account by an amount equal to the customer discount when the customer purchases the product from the merchant.

26. The method of claim 25 further comprising reimbursing the customer a portion of a customer account balance when the customer account balance exceeds a predefined threshold.

27. The method of claim 26 where the customer is reimbursed in incremental amounts.

28. The method of claim 23 further comprising providing an advertisement placement bidding system where merchants may bid for more or less prominent positions on a product display generated by the comparison shopping engine by agreeing to relatively higher or lower advertising fees associated with each completed sale of the product.

29. The method of claim 28 further comprising providing merchants an option to pay different advertising fee amounts for sales of the product to different classes of customers, and where each customer class is distinguished by a particular customer characteristic.

30. A method of advertising comprising:
agreeing to pay an adjustable advertising fee to an operator of an internet search engine comparison shopping engine adapted to display merchant advertisements offering a particular product for sale, wherein the merchants are listed in order of a final customer price calculated based on a merchant's product price and a customer discount based on the adjustable advertising fee agreed to be paid by the merchant;
providing a customer price to the internet search engine; and
adjusting the adjustable advertising fee by an amount sufficient to alter the order in which merchants are listed by the internet search engine.

31. The method of claim 30 wherein the product comprises at least one of tangible goods and services.

32. A method of creating competitive market driven advertising rates comprising:
providing an advertising space where a plurality of merchants selling a common product may place advertisements;
providing a mechanism for directing customers from the advertising space to a sales facility associated with each merchant such that sales of the product resulting from customers having been directed from the advertising space to the sales facility associated with a particular merchant may be attributed to the merchant's advertisement in the advertising space;
entering an adjustable price-per-sale advertising agreement with each of the plurality of merchants, in which each merchant agrees to pay a fee for each product sale attributed to the merchant's advertisement in the advertising space; and
arranging merchant advertisements in the advertising space based on the amount of the fee each merchant agrees to pay for each product sale, such that a merchant may improve the position of its advertisement within the advertising space by increasing the amount of the fee it agrees to pay relative to the amount of the fee agreed to be paid by other merchants.

33. The method of creating competitive market driven advertising rates of claim 32 wherein the product comprised at least one of a tangible good or service.

34. The method of creating competitive market driven advertising rates of claim 32 further comprising maintaining customer profiles identifying one or more customer characteristics and wherein the adjustable price-per-sale advertising agreement allow the merchant to pay a different fee for sales to customers having one or more different customer characteristics.

35. The method of creating competitive market driven advertising rates of claim 34 where the customer profile characteristics include demographic characteristics.

36. The method of creating competitive market driven advertising rates of claim 34 where the customer profile characteristics include geographic characteristics.

37. The method of creating competitive market driven advertising rates of claim 34 where the customer profile characteristics include purchase history characteristics.

38. The method of creating competitive market driven advertising rates of claim 34 wherein the adjustable price-per-sale advertising agreement includes a provision allowing the merchant to pay different fees for sales that occur at different times of the day.

39. The method of creating competitive market driven advertising rates of claim 32 wherein the mechanism for directing customers from the advertising space to a sales facility associated with each merchant comprises a hypertext link from a first Internet web page to a web page associated with each merchant.

40. The method of creating competitive market driven advertising rates of claim 32 further comprising offering a portion of the price-per-sale advertising fee as a discount to the customer.

41. The method of creating competitive market driven advertising rates of claim 32 further comprising offering a portion of the price-per-sale advertising fee as a contribution to an organization of the customer's choosing.

42. A method of achieving a result comprising:
defining the result;
charging a first party a fee each time the result is achieved;
sharing a portion of the fee with a second party responsible for achieving the result.

43. The method of achieving a result of claim 42 wherein the first party is a merchant selling a product, and the second party is a consumer.

44. The method of achieving a result of claim 43 wherein the result is the consumer responding to a marketing initiative initiated by the merchant

45. The method of achieving a result of claim 44 further comprising identifying consumers most likely to respond to the marketing initiative, and communicating the marketing initiative to the customers most likely to respond.

46. The method of achieving a result of claim 45 wherein responding to the marketing initiative comprises opening an email.

47. The method of achieving a result of claims 45 wherein responding to the marketing initiative comprises completing a survey.

48. The method of achieving a result of claim 45 wherein responding to the marketing initiative comprises contacting the merchant.

49. The method of achieving a result of claim 43 wherein the result is the sale of a product from the merchant to the consumer.

50. The method of achieving a result of claim 49 wherein the fee is adjustable.

51. The method of achieving a result of claim 51 wherein an amount of the fee shared with the customer is a fixed proportion of the fee paid by the merchant for the sale.

52. A method of advertising comprising:
providing an advertising medium;
presenting a merchant selling a product in the advertising medium;
charging the merchant a fee each time a specified act is performed by a customer; and
sharing a portion of the fee with the customer who performs the specified act.

53. The method of advertising of claim 52 wherein the advertising medium comprises an Internet Search Engine search results page.

54. The method of advertising of claim 52 wherein the specified act is responding to a customer query.

55. The method of advertising of claim 52 wherein the specified act is responding to a marketing initiative initiated by the merchant.

56. The method of advertising of claim 55 further comprising identifying consumers most likely to respond to the marketing initiative, and communicating the marketing initiative to the customers most likely to respond.

57. The method of advertising of claim 56 wherein responding to the marketing initiative comprises opening an email.

58. The method of advertising of claims 56 wherein responding to the marketing initiative comprises completing a survey.

59. The method advertising of claim 56 wherein responding to the marketing initiative comprises contacting the merchant.

60. The method of advertising of claim 54 wherein the specified act is the sale of a product from the merchant to the consumer.

61. The method of advertising of claim 60 wherein the fee is adjustable.

62. The method of advertising of claim 61 wherein an amount of the fee shared with the customer is a fixed proportion of the fee paid by the merchant for the sale.
